(19) United States
(12) Patent Application Publication
(10) Pub. No.: US 2003/0088810 A1
(43) Pub. Date: May 8, 2003

(54) Methods and apparatus for determining software component sizes associated with errors

(75) Inventor: Kevin A. Marshall, Newark, CA (US)

Correspondence Address: BEYER WEAVER & THOMAS LLP, P.O. BOX 778, BERKELEY, CA, 94704-0778, US

(73) Assignee: Sun Microsystems, Inc., Palo Alto, CA

(21) Appl. No.: 10/052,784

(22) Filed: Nov. 2, 2001

(51) Int. Cl. H02H 3/05

(52) U.S. Cl. 714/38

(57) ABSTRACT

Provided is a method of automatically generating data regarding errors in a software system. Contents of one or more files indicating errors in the software system are examined to determine software components responsible for the errors. The number of errors attributed to each of the software components responsible for the errors is determined. A size of the software component responsible for an error is also determined. In one embodiment, the size of the software components responsible of errors is correlated with the number of errors attributed to the software components.

### BACKGROUND OF THE INVENTION

The present invention relates generally to computer software. More particularly, the present invention relates to methods and apparatus for determining characteristics of software components associated with errors generated when those software components are executed.

Errors or bugs in software programs constitute mistakes in the code which result in the software performing in an unexpected and unintended manner. The importance of the errors can range from relatively trivial or insubstantial errors tied only to a user preference such as a screen background color to critical errors which go to the heart of the intended functioning of the program. Dealing with errors in a released version of the software generally requires a significant expenditure of resources, commencing with receiving and understanding customer complaints to providing a reworked version or revision of the files in question (a “patch”), and may even take several iterations of this process before the problems are completely resolved. Reworks comprise source code changes to files. Even prior to the initial formal release of software, the software program design process will incorporate several levels of testing. Designers typically perform significant testing of the software and may even release informal software test versions known as alpha and beta versions to elicit customer comments with the expectation that these comments will identify additional bugs prior to the formal software release.

A software system or project files will comprise a group of files, each typically having multiple components or functions contained therein. The importance of components or modules as they are sometimes known has increased with the shift towards object oriented programming. The basic premise of this programming method is to create a program from a number of linked objects or modules, each of which can individually be tested to verify operation. In this manner, a program may be compiled from modules that are known to perform correctly rather than drafting one long program performing numerous functions. These objects, modules, or functions can be defined as a grouping of computer code which together, when the program is executed by a computer, performs an identifiable function or task. In order to correct an identified bug in software, an engineer will typically generate a software patch which will contain revisions to one or more of the files constituting the software system. Typically an error fix will require that a particular function be corrected by modifying, adding, or deleting lines of code at the appropriate location in a file. The modified function or functions will appear in the new file revision released in the software patch purporting to fix the bug. Software developers vary in their practice as to documenting the bugs, the files changed to correct the particular bug, and the functions directly affected. Some employ strict policies about the documentation required, others present loose guidelines, and yet others have no policy. Typically, however, even where a uniform policy has not been instituted at a developer company, the more critical errors will receive a heightened documentation effort.

It would be desirable to focus the testing and improvement efforts on those functions or modules having a higher probability of errors rather than indiscriminately testing the software. The frequency of errors has been described as the software's fault density. Recent investigations have suggested that the size of a function bears a predictive relationship to the probability of critical errors attributable to the particular function. In particular, these studies have suggested that the smallest and the largest modules have a higher frequency of errors. While these studies have compared data from programs written in various source languages, each of the languages and operating systems within the language (such as C, ADA, or PASCAL) presents variations in such parameters as how a line of code is defined or the number of lines of code required for a given function. In order to accurately focus testing efforts or to evaluate the quality of a software program, reliability or fault density data developed specifically from the particular software system is necessary. Typically, a software system such as an operating system (“OS”) will consist of thousands of files and the number of revisions for a particular file may exceed one hundred for a mature OS. Although human analysis can be used to produce fault density data, significant human effort and time would be required to analyze rework documentation. What is needed is a method for automatically analyzing history files regarding source code changes to determine the size of a software component associated with an error.

### SUMMARY OF THE INVENTION

According to the present invention, methods and apparatus are provided for automatically generating data regarding errors in a software system. Contents of one or more files indicating errors in the software system are examined to determine software components responsible for the errors. In addition, the number of errors attributed to each of the software components responsible for the errors is determined. A size of the software components responsible for one or more errors is also determined.

In one embodiment, the size of the software components responsible for errors is correlated with the number of errors attributed to the software components. This automatically generated information provides the data which is useful to assess the quality of the software code and the probability of errors in code software components. This data is also useful as a basis for subsequent reliability studies.

In another embodiment, one or more files responsible for errors is identified. One or more file histories for the identified files is obtained. Software components responsible for the errors are ascertained form the file histories.

In yet another embodiment, contents of one or more files indicating errors in the software system are examined to determine software components responsible for the errors. Examining the contents comprises generating a list of errors and a list of files changed to correct the errors. The errors identified in the list of files are correlated with source code modifications identified in the list of errors.

### BRIEF DESCRIPTION OF THE DRAWINGS

FIG. 1 is a flowchart illustrating an overview of a method for determining the size of a function associated with an error in accordance with various embodiments of the present invention.

FIG. 2A is a flowchart illustrating a method for determining of a function associated with an error in accordance with one embodiment of the present invention.

FIG. 2B is a diagram illustrating a sample workspace history file in accordance with one embodiment of the present invention.

FIG. 2C is a flowchart illustrating details as to the method for determining a function associated with an error illustrated in FIG. 2A.

FIG. 2D is a state diagram illustrating the state of a finite state machine described with reference to the flowchart of FIG. 2C in accordance with one embodiment of the present invention.

FIG. 3A is a flowchart illustrating a method for determining a function associated with an error in accordance with one embodiment of the present invention.

FIG. 3B is a diagram illustrating a sample individual history file in accordance with one embodiment of the present invention.

FIG. 4 is a flowchart illustrating a method for determining a function associated with an error in accordance with one embodiment of the present invention.

FIG. 5 is a flowchart illustrating a method for determining a function associated with an error in accordance with one embodiment of the present invention.

FIG. 6 is a block diagram illustrating a typical, general-purpose computer system suitable for implementing the present invention.

### DETAILED DESCRIPTION OF SPECIFIC EMBODIMENTS

Reference will now be made in detail to some specific embodiments of the invention. Examples of specific embodiments are illustrated in the accompanying drawings. While the invention will be described in conjunction with these specific embodiments, it will be understood that it is not intended to limit the invention to any particular specific embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

The present invention provides methods and apparatus for automatically analyzing source files (e.g., workspace source files) containing information indicating the presence of one or more errors within a software system. For instance, such source files may contain a record of errors generated by one or more software components (i.e., procedures or functions), a record of updates (e.g., additions, modifications, or deletions to source code) and/or a record of error fixes. Through analyzing such source files, it is then possible to determine a software component size associated with an error. The size of the software components responsible for various errors in the software system may then be correlated with the number of errors attributed to the software components responsible for the errors to determine. For example, it may be determined that small software components (e.g., within a specified number of lines of code) or large software components (e.g., greater than a specified number of lines of code) are prone to error.

In the following description, various embodiments are described with reference to functions. However, such descriptions are merely illustrative. Therefore, the following description applies equally to other software components such as procedures.

In one embodiment, the method comprises examining a history log (“workspace history”) containing source code change information. From this history log a list of files which have been changed is obtained. A list of errors that have been generated historically by the listed files is also generated from the history log. Individual file histories associated with these files may then examined to determine the file versions or revisions associated with a particular error fix and to determine the line numbers corresponding to the section of code changed to effectuate the fix. In this manner, the software components responsible for various errors may be identified, thereby enabling the size of the software components to be determined.

Critical errors typically warrant changes in the source code to correct the errors. Not all bugs are equal in importance. Some bugs are so critical that considerable expenditures in labor are made to correct them. These critical errors are known by many names including escalations or escalated errors. If the first attempt or rework has not solved the problem, a subsequent file rework may be necessary. Several iterations of file source code changes (revision) may occur before a bug or error is satisfactorily resolved. As used in the context of this application, version is synonymous with file revision and refers to one of a sequential series of file revisions. A software program or operating system may comprise thousands of files and each file may have hundreds of versions.

Documentation of reworks made to correct or otherwise deal with escalated errors is typically available in greater detail than similar documentation for low priority bugs. Many software systems will store information regarding reworks, and the errors corrected, in a history file generated by maintenance software. This file is sometimes described as a workspace history. Generally, a workspace is described as an organized collection of files. Software system designers may require that a comment section regarding a patch be entered before the system will accept the patch as a file revision. Typically the workspace history will have a series of comments, each containing information identifying uniquely the error or bug (the “bug ID” or “error database identifier”) and the programmer's comments regarding information such as the nature of the bug and perhaps information identifying efforts made to rework or correct the bug. The workspace history will also typically identify the files whose source code was changed. The data contained in workspace may be insufficient to determine which sections of code were changed when the file revision fixed more than one error. Additional information necessary for correlating an error with a particular function within a file revision is typically kept in a separate file history. An individual file history often contains the entire current version for a file and thoroughly documents the changes made from the previous versions. This information regarding these changes is often referred to as a delta. The delta information, stored in the individual file history, enables the reconstruction of previous versions of the file. The delta information contains at least sufficient information to determine line numbers added or changed from a previous revision as well as bug IDs. The line numbers associated with a function within a file may then be obtained from compiled information stored as to the current file version. The line numbers associated with the function are matched against the line numbers associated with the patches for the bug IDs to determine which functions required the bug fixes.

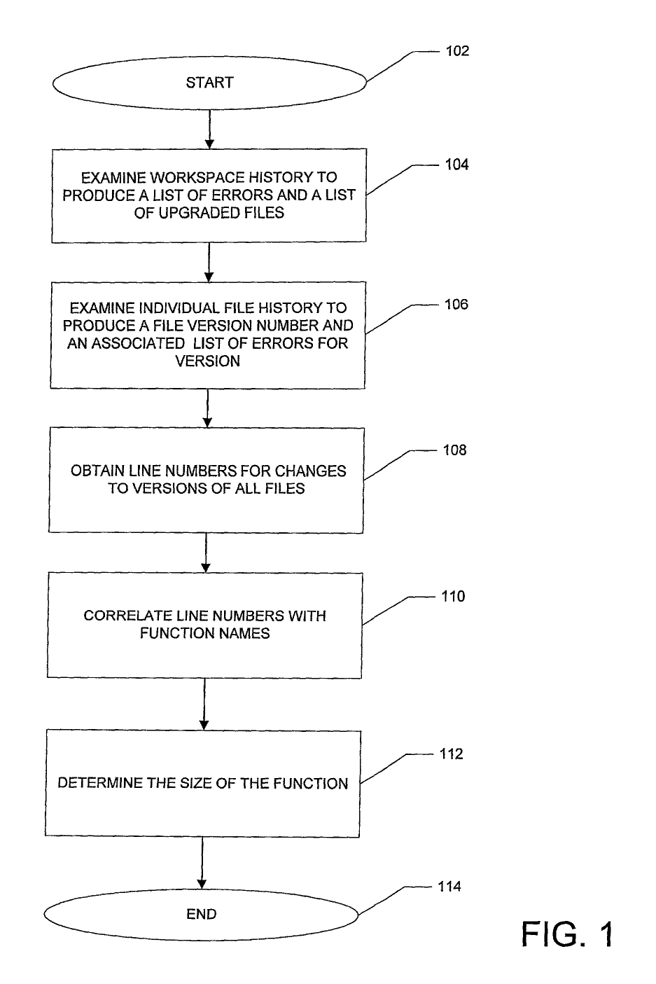

FIG. 1 is a flowchart describing an overview of the conceptual steps involved in determining the identity of a function associated with an error. After starting (102), the method commences with examining the workspace history (104). The workspace history may be described as a history of errors and source code changes. In one embodiment, the history contains error database identifiers to identify the bugs fixed. Here the comments and other historical data regarding efforts to fix the bugs enable the identification of errors fixed and files reworked in the course of fixing the errors. This information is typically insufficient to reliably correlate the bug or error IDs with the upgraded files needed to correct a particular bug. This situation results because multiple bugs may be identified in the comments section and multiple file changes or reworks may follow. This block (104) generates a list of errors and a list of reworked files but no correlation between them. The method next examines the individual file history for each file in the list of files (106). This information, in one embodiment, is maintained in a file separate from the workspace history. Generally, the file history will not contain a complete compilation for all revisions of the file, but will contain adequate information to recreate a revision. The file history contains updates, versions, and comments. The comments section of the file history for a particular file revision will typically identify by error ID number (error database identifier) one or more bugs fixed in that file revision (106).

In order to ultimately identify a function involved in error correction, the line numbers associated with the bug fix are identified. The method obtains the line numbers for changes by comparing the changed version to the preceding version (108). At this point, all line numbers for the bug fix have been obtained. There may have been many bugs fixed by one file revision and, in some cases, several revisions necessary to ultimately correct the bug. Details as to special handling rules for these cases in embodiments of the present invention are set forth later in this description. The method next correlates the line numbers associated with the bug fixes to particular functions (110). In the described embodiment, the operating system contains this matching information in a special file containing compiled information. For example, the Sun Solaris Operating System contains a source browser data file which identifies, for a current version, the function names and the line numbers for the start and end lines for the functions. Finally, the method specifies the size of the function from the function start and end lines (112).

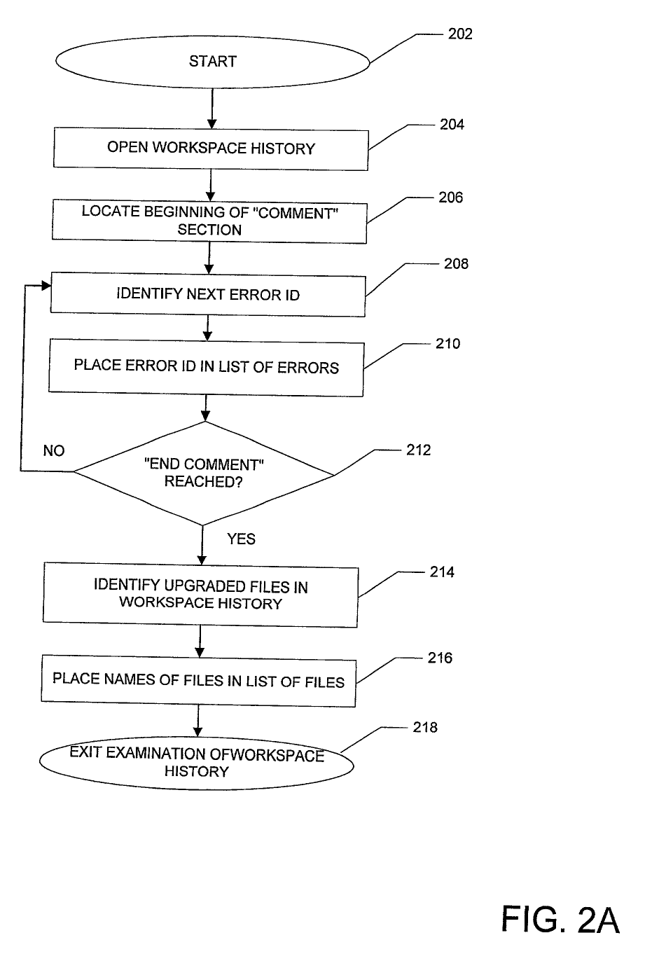

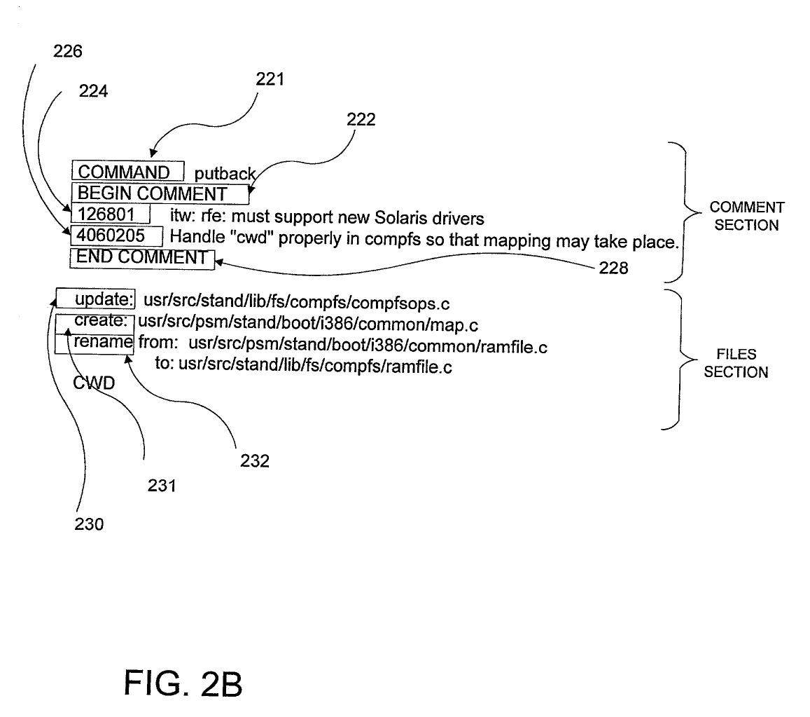

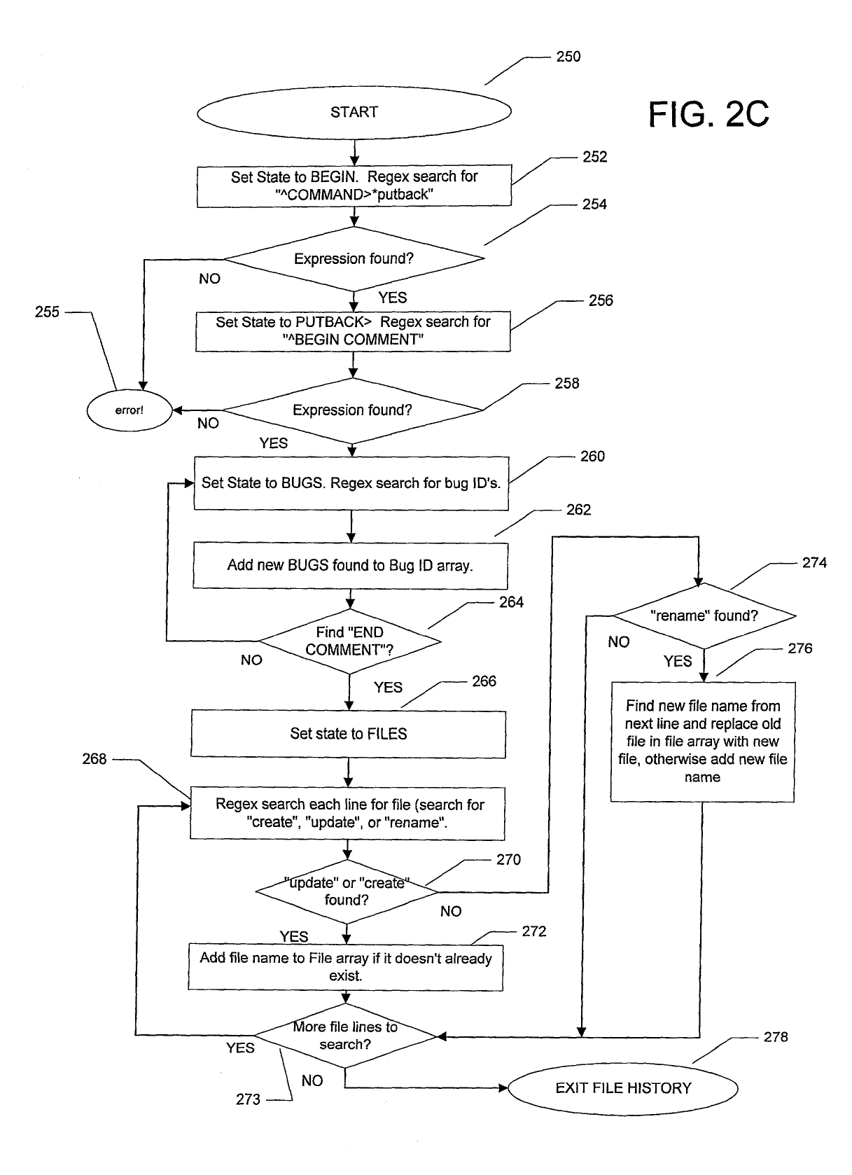

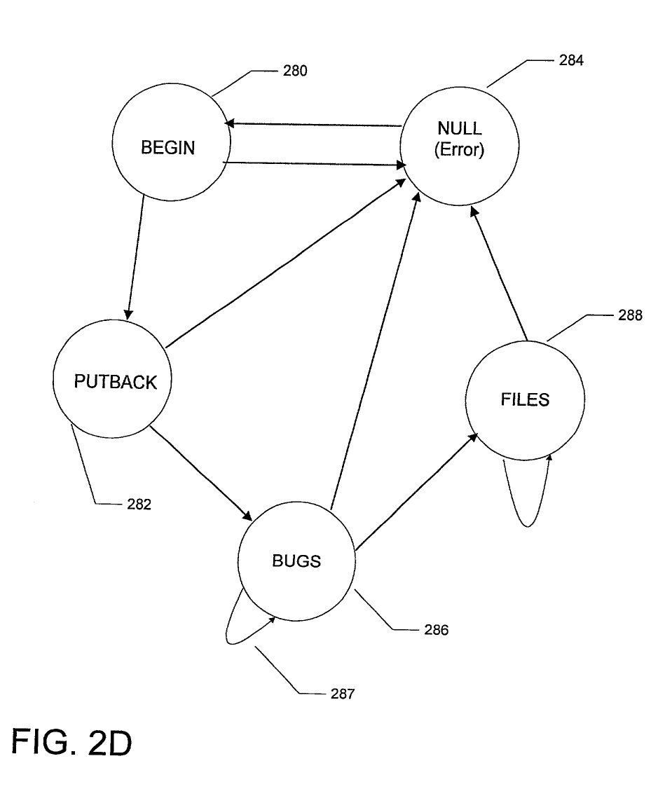

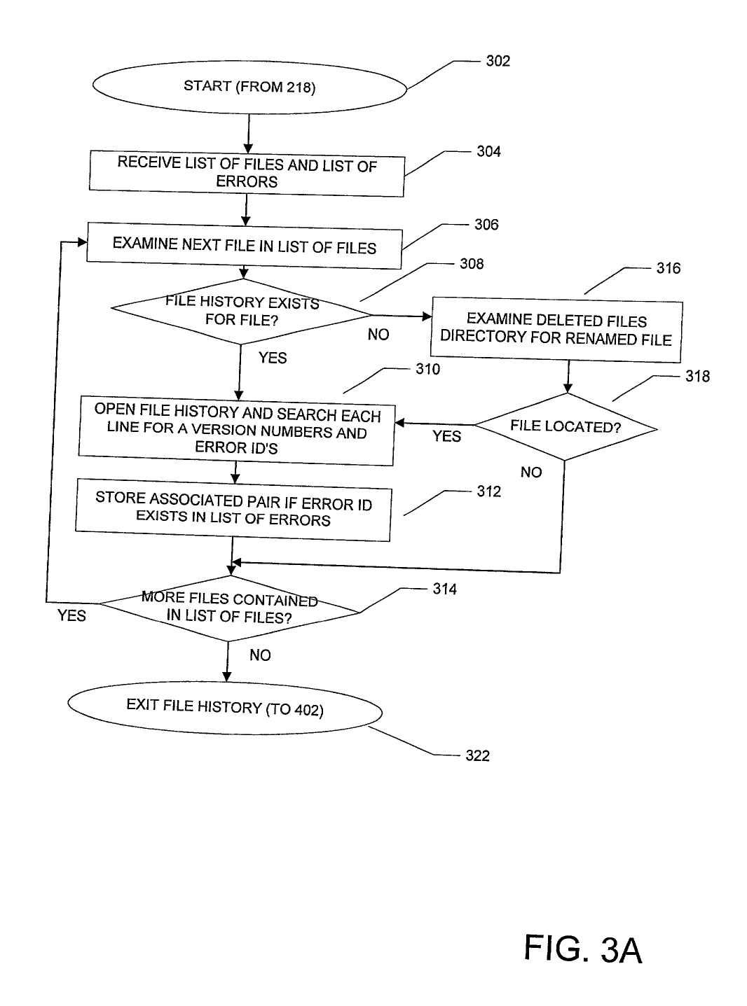

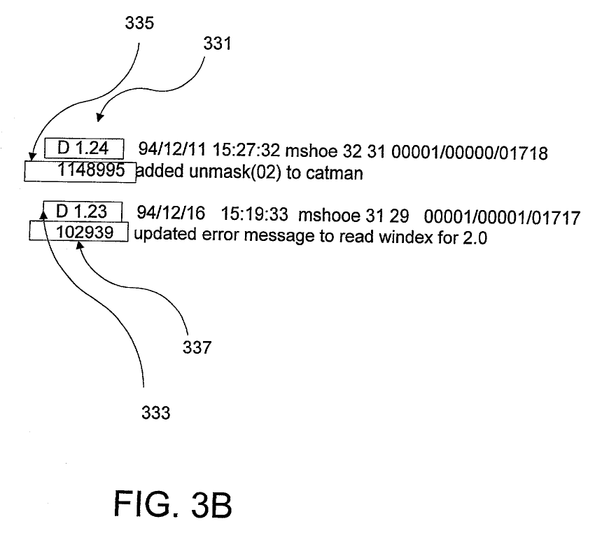

Further details as to the examination of the workspace history (104) are shown in FIG. 2A. In one embodiment, each putback section of the history comprises a comments section and a files section. The comments section, for example, contains a section of text in one embodiment. The comments section contains database identifiers. The files section follows the comments. After the method opens the workspace history (204), it locates the beginning of the comment section (206). This section, in one embodiment, contains an ID of the bug or error fixed and further comments describing the nature of the bugs or fixes or the both of them. In particular, the flowchart depicts the method used when the file revised is introduced by an update, create, or rename command. Often multiple error IDs will be contained in the comment section. The method identifies the next error ID (208), places it into the list of errors (210), and repeats until the end comment is reached (212). Separately, a list of files upgraded is produced by first identifying the file names of the revised files as identified in the workplace history (214). After identification, the file names are placed in a separate list (216). In one embodiment, the workspace history file will contain a comment section identifying the various error IDs associated with the patch and a list of files revised following the comment section. Although many of the descriptions pertain to this data structure, it will be recognized that techniques adaptable to different data structures in the workspace history and individual file histories are known to those of skill in the relevant art and the present invention is not limited to the described data structure. The method then stops examining the workplace history (218). The method then proceeds to step 302 as shown in FIG. 3A.

FIG. 2B shows an example of the information contained within a sample workspace history file. The “BEGIN COMMENT” entry (222) is used in this embodiment as an indication that the comment section that follows may contain error IDs which here are 7 digit numbers (224 and 226). The “END Comment” (228) statement is interpreted by the method as a signal that no more error IDs remain in the section. The method further detects commands such as “update” (230), “create” (231), or “rename” (232) as indications that files that have changed follow.

The method typically employs character string searches to locate error ID numbers and file names associated with file upgrades. Character string searches are also known as regular expression searches. FIG. 2C is an expansion of FIG. 2A and provides further detail as to the use of character string searches for steps 206-218, as shown in FIG. 2A. In order to locate the beginning of the comment section pertaining to a patch or putback, a regular expression search for the string “command putback” commences (252). A finite state machine concept is employed by the software to track the states of the detection scheme. Initially, the state is set to “Begin”. If the expression is found, the search continues (254). If no section is indicated, an error message is generated (255). If the “Command putback” string is located, the state is changed to “Putback” and a regular expression search for the beginning of the comments section ensues (256). If the method locates the beginning of the comment, the state is set to “Bugs” and a character string search follows for the error ID numbers (258, 260). Any new error IDs found are added to the list of errors (Bug ID array) (262). If the method locates the “END COMMENT” string, the state is changed to “Files” and a regular expression search of each line follows for an indication of a file changed (266, 268). Alternately, if the end of the comment section has not yet been reached, searching for additional error IDs follows (264, 260). Typical expression referencing file reworks are “create”, “update”, or “rename”. For example, Code Manager is a product licensed by Sun Microsystems, Inc. which performs each of these file rework activities and documents these reworks using “create”, “update”, or “rename” designations. If an update or “create” is found, the file name is added to the file array if it isn't already existent in that array (270). For example, a file name may have been added previously to the array in response to a different bug fix. After the new file is added as appropriate, a regular expression search of the next line continues if more lines remain (273, 268). Since “renamed” files are treated differently from “updated” files, where no “update” or “create” command is located on a line, a search for a “rename” command follows (274). When renamed files are located, the old file name is determined from the same line and replaced in the file array if the old file name is present (274, 276). Otherwise the new file name is added to the list of files. If no more file lines exist to search, the workspace history is exited (273, 278) and the method proceeds to step 302 as shown in FIG. 3A.

FIG. 2D is a state diagram illustrating the various states utilized in the string searches described with reference to FIG. 2C. The “Begin” state (280) permits a transition to a “Putback” state (282) if the character string search successfully locates a “Command putback” command as indicated with respect to the discussion of FIG. 2C. Failure to locate such a character string would result in a transition to the “Null” state (284), signifying an unsuccessful search. The next states available from the “Putback” state (282) are either the “Bugs” state (286) or the “Null” state (284), the latter transition occurring when no error IDs are located. Sequential searches of each line for additional error IDs are represented by the loop arrow (287), indicating that the next state from a “Bugs” state is “Bugs” state (286), “Files” state (288), or the “Null” state (284). Sequential searching of each line occurs also in the “Files” state, as depicted by the transition loop arrow (289).

A search of the file history permits correlation of error IDs with particular file revisions and ultimately a particular function or module within the file revision. FIG. 3A is a flowchart illustrating the correlation of an error ID with a file revision in accordance with one embodiment of the present invention. These steps depicted in the flowchart correspond generally to block 106 in FIG. 1. After examination of the workspace history is completed in step 218 (see FIG. 2A), the method will retrieve a list of files and a list of errors obtained in the examination of the workspace history (304). Examination will proceed with the first file name in the list of files (306). If an individual file history exists, that history is opened and each line is searched for version numbers and error IDs (308, 310). Typically, the individual file history will designate a version number followed by the ID numbers for the errors corrected by the file revision.

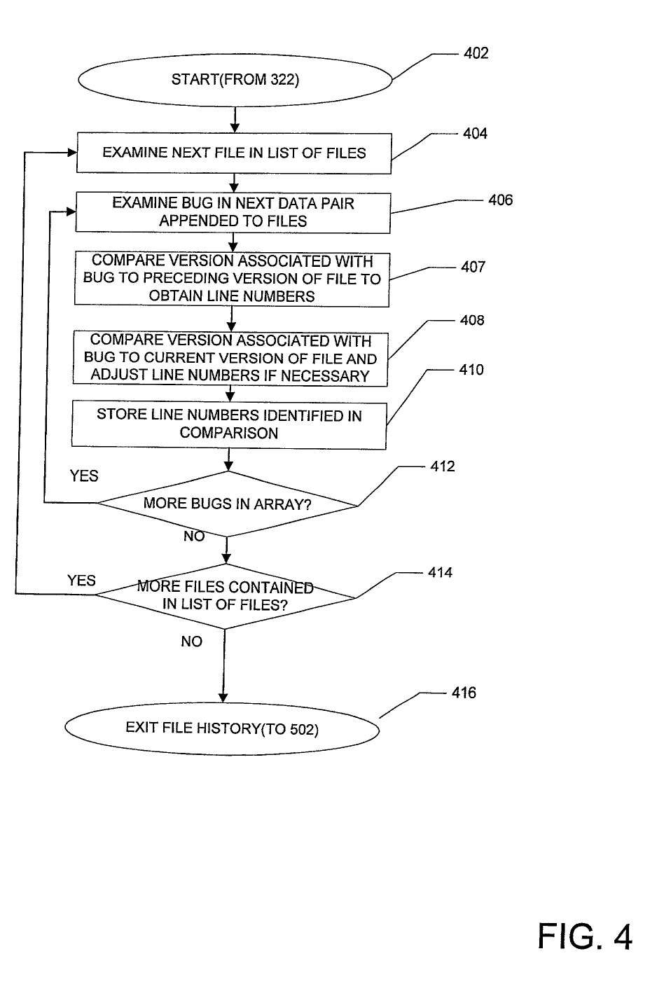

Once an error ID is determined to correspond to a file version, a check is performed to determine if the error ID exists in the list of errors (312). Where this match occurs, the data pair (“error/version data pair”) representing the file version and the error ID is stored, followed by a sequential examination of the next file (306-312). This step is important to differentiate minor errors which might be noted in the file histories from the major or escalated errors which are the focus of the method of the present invention and are the only errors identified from the workspace history. Where no file history exists for one of the files listed in the list of files, a deleted files directory is examined for identification of a renamed file (316). Where a renamed file is located, that file directory is searched and an associated data pair stored as described above (318, 310-312). In addition, all file revisions for the old file name are stored for later use in determining line numbers for sections of changed code. If a renamed file is not located, a sequential examination of the next file (306-312) occurs if the determination is made that more files in the list of files remain to be examined (314). Once the file histories for all files identified in the list of files have been examined, the method exits the file histories (322) and proceeds to step 402 as depicted in FIG. 4. The version/error data pairs generated will include a list of file revisions for all files upgrades and the error IDs corrected in that file revision. The method relies on the fact that error IDs appear in the comment section pertaining to the file revision in which the errors were corrected. An error ID may appear more than once in the same individual file history. In this case, the latest file version will be correlated with the error. This embodiment assumes that the latest version best reflects a successful fix to the error.

FIG. 3B is a diagram illustrating a sample individual history file in accordance with one embodiment of the present invention. This fragment of the individual file history identifies revisions D 1.24 and D 1.23 (331,333), indicating that to the point examined, there were 23 different versions of the file. Not all 23 would necessarily appear in the list of data pairs described with reference to FIG. 3A, since some revisions might pertain only to insubstantial errors not identified from the workspace history. Error ID numbers (335 and 337) are seven digit numbers. This data from the individual history file, as shown, enables the correlation of error ID 1148995 in the example to file revision D 1.24. If this error ID exists in the list of errors previously generated, the method stores the error/version data pair. In some cases, the comments section in the individual file history may contain several error Ids. This situation is handled in one embodiment by attributing all changes made in the version to each error ID. For example, when three error ID numbers appear in the comment section pertaining to a file revision, three data pairs would be generated.

Determining the particular functions involved in bug fixes requires first a determination as to the line numbers for the section of code associated with a bug fix. FIG. 4 illustrates a method of identifying the lines changed in a file revision, in accordance with one embodiment of the present invention and corresponds generally to block 108 in FIG. 1. In one embodiment of the method, only the versions affected by major or escalated bug fixes are examined. For each file in the list of files a listing of versions is relied upon to determine the line numbers for the sections of code changed Each file in the list of files has associated with it a list of version/error data pairs generated by the method illustrated in FIG. 3A. Each file is sequentially examined to generate the line numbers for the sections of code changed (404). Each error ID in the data pair is examined to find the corresponding line number (406). In order to make the determination as to the line numbers changed in a revision, the file history information is examined to determine the changes between the revision correcting the error and the preceding version of the file (407).

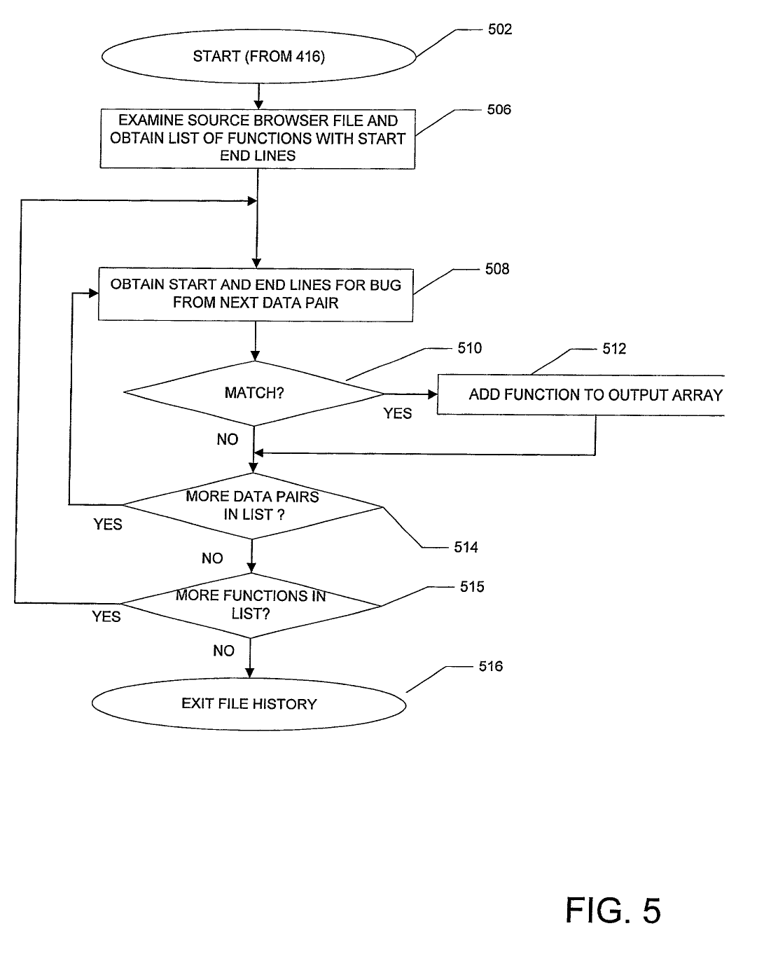

For example, revision D 1.24 to file kmem.c may have added lines 11-15 to correct the identified error. Comparison of revision D 1.24 to the preceding revision D 1.23 might reveal, for example, that 5 lines were added after line 10 to correct the identified error. Once these line numbers are obtained, the line numbers are converted to correspond to the most current version of the file (408). In many cases this will be unnecessary when no changes have taken place in the interim versions to change the start and end lines for the code section identified above. However, an offset is determined when changes in interim file revisions affect the current location of this code section (408). Such an offset would permit an accurate determination as to the location of the start and end lines of the revised lines of code in the current file version and is necessary to correlate the line numbers with the module or function line numbers designated in a later step, as shown in FIG. 5. The line numbers identified are stored in a listing associated with the error identification number (410). Subsequently, the remaining version/error data pairs in the list are examined to obtain the line number changes for all remaining bugs associated with that file (412 and 406-410). This procedure continues for all remaining files in the list of files (414, and 404-412). If no more files are found in the list of files, the method exits the individual file histories (416).

The difference calculated between the version correcting the error and the preceding version may generate more than one section of code. In this special circumstance, the method applies each section of changed code to the error ID. This helps ensure that each module or function identified will cross-reference all escalated error identification numbers which required that the module be revised. This technique likely involves some overcounting but is believed to have a minimal effect on the quality of the data generated.

Derivation of the size of the function generating an error further involves identifying the start and end lines of each function. The method, in one embodiment, uses the operating system's source browser file which identifies the start and end lines for each function compiled. For example, the Sun Solaris system stores in a workspace the source browser data file which maintains this function information for the currently compiled version. FIG. 5 is a flowchart illustrating the matching of functions with line changes in accordance with one embodiment of the present invention and corresponds generally to block 110 in FIG. 1. The flowchart depicted in FIG. 5 shows the method steps occurring after step 416 shown in FIG. 4. Initially the source browser data file is examined to directly obtain the start and end lines for each function (506). For each bug in the recently generated data pair, the start and end lines for the function are compared with the start and end lines for the bug fix, as stored with the data pair in step 410, FIG. 4 (508). Where a match occurs, the function is added to a data structure such as an output array (510, 512). Start and end lines for each of the data pairs are examined for a potential match with the function start and end lines until no data pairs remain in the list (514). This method repeats for each remaining function identified in the list of functions (515, 508-514). At this point the method exits from the file history (516). The function size, for those functions associated with a bug fix, is determined by finding the difference between the function start and end lines determined earlier (506). This step corresponds to block 112 in FIG. 1.

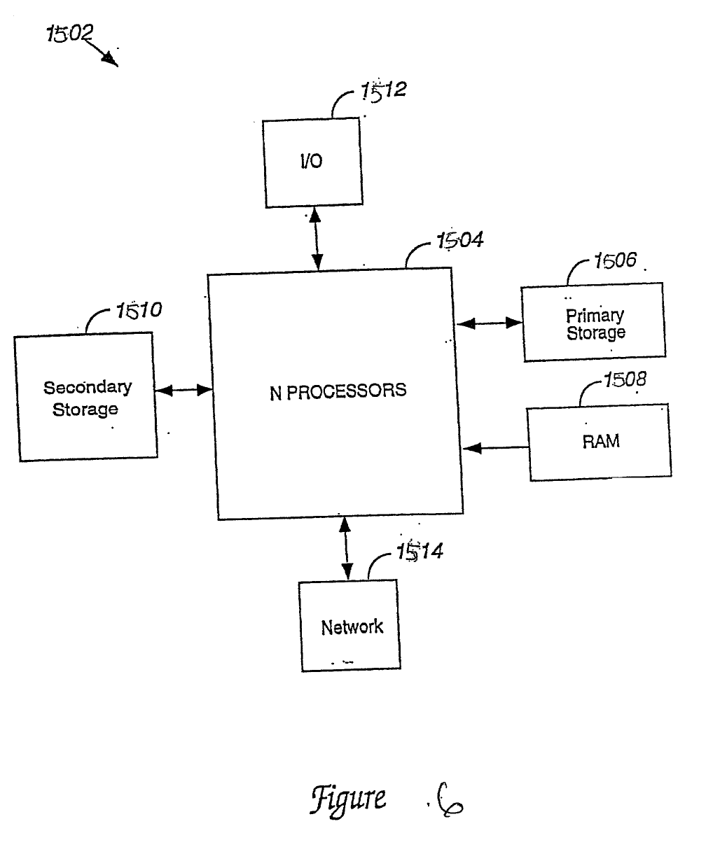

The present invention may be implemented on any suitable computer system. FIG. 6 illustrates a typical, general-purpose computer system 1502 suitable for implementing the present invention. The computer system may take any suitable form. For example, the computer system may be integrated with a digital television receiver or set top box. Thus, such a computer system may be used to execute a process or implement a user interface mechanism in accordance with above-described embodiments of the invention.

Computer system 1530 or, more specifically, CPUs 1532, maybe arranged to support a virtual machine, as will be appreciated by those skilled in the art. The computer system 1502 includes any number of processors 1504 (also referred to as central processing units, or CPUs) that may be coupled to memory devices including primary storage device 1506 (typically a read only memory, or ROM) and primary storage device 1508 (typically a random access memory, or RAM). As is well known in the art, ROM acts to transfer data and instructions uni-directionally to the CPUs 1504, while RAM is used typically to transfer data and instructions in a bi-directional manner. Both the primary storage devices 1506, 1508 may include any suitable computer-readable media. The CPUs 1504 may generally include any number of processors.

A secondary storage medium 1510, which is typically a mass memory device, may also be coupled bi-directionally to CPUs 1504 and provides additional data storage capacity. The mass memory device 1510 is a computer-readable medium that may be used to store programs including computer code, data, and the like. Typically, the mass memory device 1510 is a storage medium such as a hard disk which is generally slower than primary storage devices 1506, 1508.

The CPUs 1504 may also be coupled to one or more input/output devices 1512 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, the CPUs 1504 optionally may be coupled to a computer or telecommunications network, e.g., an internet network or an intranet network, using a network connection as shown generally at 1514. With such a network connection, it is contemplated that the CPUs 1504 might receive information from the network, or might output information to the network in the course of performing the above-described method steps. Such information, which is often represented as a sequence of instructions to be executed using the CPUs 1504, may be received from and outputted to the network, for example, in the form of a computer data signal embodied in a carrier wave.

While the invention has been particularly shown and described with reference to specific embodiments, it will be understood by those skilled in the art that other details may be made without departing from the spirit or scope of the invention. For example, many different types of display and interface devices can be used other than those listed in the foregoing embodiments. Furthermore, certain terminology has been used to aid in the description of the embodiments but was not intended to limit the present invention. For example, the term array has been used in various instances to identify elements present in a list of elements. However, those of ordinary skill in the art will readily recognize that alternate data structures such as a linked list may also be implemented. Therefore, in view of the foregoing, the scope of the invention should be determined by reference to the appended claims.

What is claimed is:

1. A method of automatically generating data regarding errors in a software system, the software system including one or more software components, the method comprising:
examining contents of one or more files indicating one or more errors in the software system to determine one or more of the software components responsible for the errors and a number of the errors attributed to each of the software components determined to be responsible for the errors; and
determining a size of the one or more software components responsible for the errors.

2. The method as recited in claim 1, further comprising correlating the size of the determined software components with the number of errors attributed to the determined software components, thereby enabling data indicating a probability of errors occurring during execution of a set of software components to be generated from the determined size of the software components determined to be responsible for the errors and the number of the errors attributed to each of the software components determined to be responsible for the errors.

3. The method as recited in claim 1, wherein one or more of the files examined comprises a history of one or more errors generated during execution of the software system.

4. The method as recited in claim 3, wherein the contents of one or more files examined further indicates one or more source code modifications made in response to the errors.

5. The method as recited in claim 4, wherein determining from the one or more files one or more of the software components responsible for the errors comprises:
determining from the source code modifications one or more software components modified to correct the errors.

6. The method as recited in claim 1, further comprising:
ascertaining from the size of the one or more software components a set of software components that are prone to error.

7. The method as recited in claim 1, wherein examining contents of one or more files indicating one or more errors in the software system comprises generating a list of one or more errors corresponding to source code changes and a list of one or more files associated with successful attempts to correct the errors.

8. The method as recited in claim 7, wherein examining contents of one or more files further comprises correlating a file in the list of files associated with successful attempts to correct the errors with one of the source code changes corresponding to at least one of the list of errors.

9. The method as recited in claim 8, wherein wherein the correlating a file in the list of files associated with successful attempts to correct the errors with one of the source code changes corresponding to at least one of the list of errors comprises examining an individual file history for at least one file in the list of files.

10. The method as recited in claim 1, wherein determining a size of the one or more functions responsible for the errors comprises determining start and end lines of a section of code modified to fix an error.

11. The method as recited in claim 10, further comprising converting the start and end lines of a section of code modified to the start and end lines of a current version of a file

12. The method as recited in claim 10, further comprising determining the one or more software components responsible for the errors from the current version of the file.

13. The method as recited in claim 7, wherein the list of files contains information identifying the version of the file and one or more identifiers to identify one or more errors associated with the version of the file.

14. The method as recited in claim 13, wherein the errors corresponding to source code changes are matched against one or more identifiers associated with a file version.

15. The method as recited in claim 1, wherein the errors exceed a certain level of priority.

16. The method as recited in claim 1, further comprising:
identifying one or more files responsible for the errors;
obtaining one or more file histories associated with the files responsible for the errors; and
ascertaining from the file histories the one or more software components responsible for the errors.

17. The method as recited in claim 16, wherein ascertaining from the file histories the one or more software components responsible for the errors further comprises:
ascertaining from the file histories one or more line numbers associated with the software components responsible for the errors.

18. The method as recited in claim 17, wherein ascertaining from the file histories one or more line numbers associated with the software components responsible for the errors comprises:
matching one or more line numbers associated with modified source code against compiled information associated with the source code.

19. The method as recited in claim 18, further comprising:
determining the one or more line numbers associated with the modified source code from one or more error identifiers present in the file histories.

20. The method as recited in claim 18, further comprising:
comparing information associated with one or more versions of the source code to determine the one or more line numbers associated with the modified source code.

21. The method as recited in claim 17, wherein the one or more line numbers associated with the software components responsible for the errors includes a start line and an end line associated with the software components responsible for the errors, wherein determining a size of the software components responsible for the errors is performed from the start line and the end line associated with the software components responsible for the errors.

22. A computer-readable medium storing thereon instructions for automatically generating data regarding errors in a software system, the software system including one or more software components, comprising:
instructions for examining contents of one or more files indicating one or more errors in the software system to determine one or more of the software components responsible for the errors and a number of the errors attributed to each of the software components determined to be responsible for the errors; and
instructions for determining a size of the one or more software components responsible for the errors.

23. An apparatus for automatically generating data regarding errors in a software system, the software system including one or more software components, comprising:
means for examining contents of one or more files indicating one or more errors in the software system to determine one or more of the software components responsible for the errors and a number of the errors attributed to each of the software components determined to be responsible for the errors; and
means for determining a size of the one or more software components responsible for the errors.

24. An apparatus for automatically generating data regarding errors in a software system, the software system including one or more software components, the method comprising:
a processor; and
a memory, at least one of the processor and the memory being adapted for:
examining contents of one or more files indicating one or more errors in the software system to determine one or more of the software components responsible for the errors and a number of the errors attributed to each of the software components determined to be responsible for the errors; and
determining a size of the one or more software components responsible for the errors.
